(19) United States
(12) Patent Application Publication
(10) Pub. No.: US 2019/0287489 A1
(43) Pub. Date: Sep. 19, 2019

(54) HEAD-MOUNTED DISPLAY APPARATUS AND METHOD FOR CONTROLLING HEAD-MOUNTED DISPLAY APPARATUS

(71) Applicant: SEIKO EPSON CORPORATION, Tokyo (JP)

(72) Inventor: Takashi TOMIZAWA, Chiisagata-gun (JP)

(73) Assignee: SEIKO EPSON CORPORATION, Tokyo (JP)

(21) Appl. No.: 16/356,188

(22) Filed: Mar. 18, 2019

(30) Foreign Application Priority Data
Mar. 19, 2018 (JP) 2018-050713

(51) Int. Cl. G09G 5/37; G02B 27/01; G09G 5/00; G06F 3/01; G06F 3/0482; G06T 7/20; G06F 3/0484

(52) U.S. Cl. CPC G09G 5/37; G02B 27/0172; G09G 5/006; G06F 3/011; G06F 3/0482; G06T 7/90; G06F 3/04845; G02B 2027/0138; G02B 2027/014; G09G 2354/00; G06T 2207/30196; G06T 7/20

(57) ABSTRACT

Provided is an HMD that includes an image display unit to be mounted on a head of a user and configured to transmit an external scene to be visually recognizable, a camera configured to capture a range including the external scene transmitted through the image display unit to be visually recognized, and a control unit configured to detect an indicator from captured image data of the camera, cause the image display unit to display the object image superimposed on the external scene, and cause a display mode of the object image overlapping the detected indicator, of the object images displayed on the image display unit to be changed.

### BACKGROUND

### 1. Technical Field

The invention relates to a head-mounted display apparatus and a method for controlling the head-mounted display apparatus.

### 2. Related Art

Previously, head-mounted display apparatuses (head-mounted displays, also denoted as HMDs below) as a display apparatus worn by a user on a head have been known. As for the HMDs, various techniques for improving operability have been proposed (for example, see JP-A-2017-126899).

JP-A-2017-126899 discloses an image processing device for determining an image playback speed, when an image with a size exceeding a field of view of a viewer is displayed using a head-mounted display apparatus, based on information about a face direction of the viewer.

Meanwhile, in a head-mounted display apparatus for displaying an image together with an external scene in a visually recognizable manner, as an input method, an operation method has been known in which an operation of an indicator on an image displayed by the head-mounted display apparatus is detected by an imaging unit, and processing corresponding to the detected operation is performed. In this operation method, there is room for improvement of operability. For example, it is necessary to allow a user to recognize whether the operation detected by the head-mounted display apparatus is an operation intended by the user or not.

### SUMMARY

An advantage of some aspects of the invention is to improve operability of an operation on an object image performed using an indicator.

An aspect of the invention includes a display unit to be mounted on a head of a user and configured to transmit an external scene to be visually recognizable, an imaging unit configured to capture a range including the external scene transmitted through the display unit to be visually recognized, a detection unit configured to detect an indicator from a captured image of the imaging unit, and a display controller that is configured to cause the display unit to display the object image superimposed on the external scene, and that is configured to cause a display mode of the object image overlapping the indicator detected by the detection unit, of the object images displayed on the display unit, to be changed.

This configuration can allow the user to recognize the object image detected by the detection unit, and can improve the operability of the operation on the object image.

Additionally, according to an aspect of the invention, the display controller is configured to cause the display mode of the object image to be changed when overlap of the indicator and the object image is detected.

This configuration can allow the user to recognize the object image for which the overlap of the indicator is detected.

Additionally, according to an aspect of the invention, the display controller is configured to cause the display mode of the object image to be changed between when overlap of the indicator and the object image is detected, and when movement of the indicator on the object image is detected.

This configuration can allow the user to recognize the object image for which the overlap of the indicator is detected, and allow the user to recognize that an operation on the object image is detected.

Additionally, according to an aspect of the invention, the display controller is configured to cause the display mode of the object image to be changed corresponding to movement of the indicator on the object image.

This configuration can allow the user to recognize an operation of the indicator on the object image.

Additionally, according to an aspect of the invention, the display controller is configured to cause processing associated with the object image to be performed when the display mode of the object image is changed corresponding to movement of the indicator on the object image.

According to this configuration, the display mode of the object image can be changed by the movement of the indicator on the object image, and when the display mode of the object image is changed, the processing associated with the object image can be performed.

Additionally, according to an aspect of the invention, each of the object images is associated with a processing command, and the display controller is configured to cause the display unit to display a profile line indicating an outline of the object image associated with an acceptable processing command, of the object images.

According to this configuration, the profile line indicating the outline of the object image is displayed.

Additionally, according to an aspect of the invention, the display controller is configured to, when overlap of the indicator and the object image is detected, cause a line type of a profile line of the object image for which the overlap is detected to be changed to change the display mode of the object image.

This configuration can allow the user to recognize the object image for which the overlap of the indicator is detected, by changing the line type of the profile line of the object image.

Additionally, according to an aspect of the invention, the display controller is configured to cause at least one of hue, brightness, chroma, and transparency of the object image to be changed corresponding to movement of the indicator on the object image.

This configuration can allow the user to recognize the movement of the indicator in a region on which the object image is displayed.

Additionally, according to an aspect of the invention, the detection unit is configured to detect the indicator captured on the captured image, based on a color, a shape, or a color and shape of the indicator.

According to this configuration, detection accuracy of the indicator can be enhanced.

An aspect of the invention is a method for controlling a head-mounted display apparatus to be mounted on a head of a user and configured to transmit an external scene to be visually recognizable, and includes displaying an object image superimposed on the external scene, detecting an indicator from a captured image captured by an imaging unit, and causing a display mode of the object image overlapping the detected indicator, of the displayed object images, to be changed.

### BRIEF DESCRIPTION OF THE DRAWINGS

The invention will be described with reference to the accompanying drawings, wherein like numbers reference like elements.

FIG. 1 is an explanatory view illustrating an external configuration of an HMD.

FIG. 2 is a block diagram illustrating a configuration of the HMD.

FIG. 3 is a functional block diagram of a control device.

FIG. 4 is a diagram illustrating a state in which an operation screen as an image is displayed on a display region.

FIG. 5 is a flowchart illustrating operations of the HMD.

FIG. 6 is a diagram illustrating the operation screen displayed on the display region.

FIG. 7 is a diagram illustrating an expanded and displayed tag.

FIG. 8 is a diagram illustrating the operation screen displayed on the display region.

FIG. 9 is a diagram illustrating the operation screen displayed on the display region.

FIG. 10 is a diagram illustrating the operation screen displayed on the display region.

FIG. 11 is a diagram illustrating the operation screen displayed on the display region.

FIG. 12 is a diagram illustrating the operation screen displayed on the display region.

FIG. 13 is a diagram illustrating the operation screen displayed on the display region.

FIG. 14 is a diagram illustrating the operation screen displayed on the display region.

FIG. 15 is a diagram illustrating a sub menu screen displayed on the display region.

FIG. 16 is a diagram illustrating a character input scene.

FIG. 17 is a diagram illustrating the character input scene.

FIG. 18 is a diagram illustrating an application screen displayed on the display region.

FIG. 19 is a diagram illustrating the application screen displayed on the display region.

FIG. 20 is a diagram illustrating the application screen displayed on the display region.

FIG. 21 is a diagram illustrating the application screen displayed on the display region.

FIG. 22 is a diagram illustrating the application screen displayed on the display region.

### DESCRIPTION OF EXEMPLARY EMBODIMENTS

Exemplary Embodiments of the invention will now be described herein with reference to the accompanying drawings.

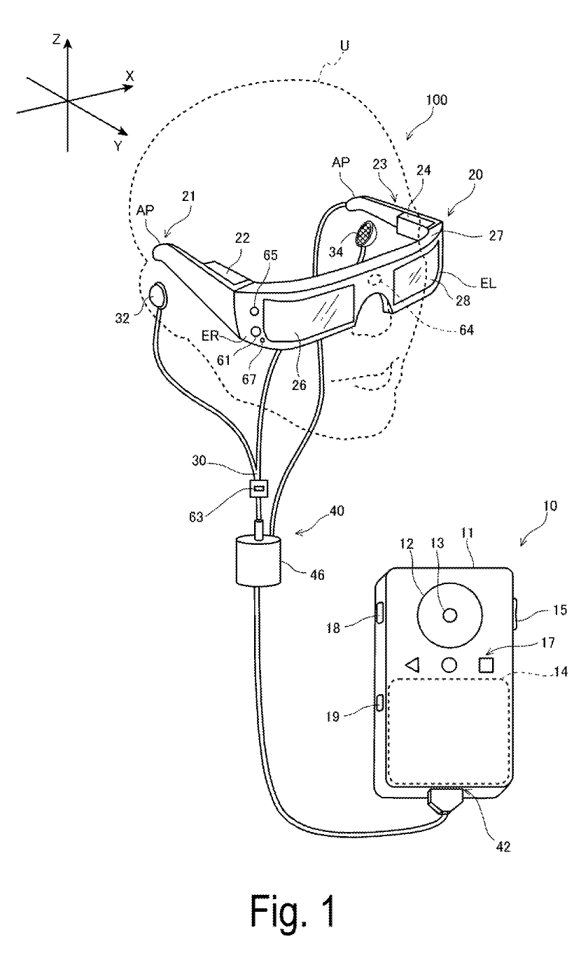

FIG. 1 is a view illustrating an external configuration of a head-mounted display (HMD) 100.

The HMD 100 includes an image display unit 20 to be worn on a head of a user U, and a controller 10 configured to control the image display unit 20. The image display unit 20 represents a functional unit configured to perform operations corresponding to operations of the “display unit” according to the invention. While being worn on the head of the user U, the image display unit 20 allows the user U to visually recognize a virtual image. The controller 10 also functions as a control device used to operate the HMD 100 by the user U.

On a main body 11 having a box shape, the controller 10 includes various switches and an operation pad 14, for example, configured to accept operations by the user U. The image display unit 20 has an eyeglass shape in the exemplary embodiment, and includes a right holding part 21, a left holding part 23, a front frame 27, a right display unit 22, a left display unit 24, a right light-guiding plate 26, and a left light-guiding plate 28.

The right holding part 21 and the left holding part 23 extend rearward from corresponding ends of the front frame 27, to hold the image display unit 20 on the head of the user U. One of the ends of the front frame 27, which lies on the right side of the user U when s/he wears the image display unit 20, is referred to as an end ER, while the other one of the ends, which lies on the left side, is referred to as an end EL.

The right light-guiding plate 26 and the left light-guiding plate 28 are provided on the front frame 27. While the image display unit 20 is worn, the right light-guiding plate 26 lies in front of a right eye of the user U, while the left light-guiding plate 28 lies in front of a left eye of the user U.

The right display unit 22 and the left display unit 24 are a module in which an optical unit and a peripheral circuit are unitized, and are configured to emit an imaging light. The right display unit 22 is attached to the right holding part 21 and the left display unit 24 is attached to the left holding part 23.

The right light-guiding plate 26 and the left light-guiding plate 28 are optical components made of a light transmissive resin or the like. The right light-guiding plate 26 and the left light-guiding plate 28 are prisms, for example. The right light-guiding plate 26 guides imaging light output by the right display unit 22 to the right eye of the user U, while the left light-guiding plate 28 guides imaging light output by the left display unit 24 to the left eye of the user U. Therefore, the imaging light enters into both of the eyes of the user U. The user U can thus view an image.

The HMD 100 is a see-through type display apparatus. The imaging light guided by the right light-guiding plate 26 and outside light passed through the right light-guiding plate 26 enter into a right eye RE of the user U. Similarly, the imaging light guided by the left light-guiding plate 28 and outside light passing through the left light-guiding plate 28 enter a left eye LE. As described above, the HMD 100 causes imaging light corresponding to an image processed internally and outside light to overlap each other and enter into the eyes of the user

U. The user U views, through the right light-guiding plate 26 and the left light-guiding plate 28, the image formed from the imaging light overlapping the external scene.

An illuminance sensor 65 is arranged on the front frame 27 of the image display unit 20. The illuminance sensor 65 is configured to receive outside light coming from in front of the user U wearing the image display unit 20.

A camera 61 is disposed on the front frame 27 of the image display unit 20. An imaging range and an imaging direction of the camera 61 will be described later. The camera 61 is provided at a position so that the camera 61 does not block the outside light passing through the right light-guiding plate 26 and the left light-guiding plate 28. In FIG. 1, a case in which the camera 61 is arranged on the end ER side of the front frame 27 is illustrated. However, the camera 61 may be arranged on the end EL side or at the connection between the right light-guiding plate 26 and the left light-guiding plate 28. The camera 61 corresponds to the “imaging unit” of the invention.

The camera 61 is a digital camera including an imaging element such as a CCD and a CMOS, an imaging lens and the like, and the camera 61 according to the exemplary embodiment is a monocular camera, but may include a stereo camera. The camera 61 captures an image of at least a part of the external scene (real space) in a visual field direction of the user U wearing the HMD 100. An angle of view of the camera 61 faces in a front direction of the user U and overlaps the external scene viewed by the user U through the image display unit 20. A more preferable angle of view of the camera 61 covers a whole visual field, through the image display unit 20, of the user U. The camera 61 is configured to capture an image in accordance with a control by the control unit 150, and output captured image data to the control unit 150.

An LED indicator 67 is arranged in the front frame 27. The LED indicator 67 is arranged adjacent to the camera 61 at the end ER and is configured to turn on while the camera 61 is operating to notify that the capturing is in progress.

The front frame 27 is provided with a distance sensor 64. The distance sensor 64 is configured to detect a distance to an object to be measured and located in a preset measurement direction. In the exemplary embodiment, the distance sensor 64 detects a distance to the object to be measured lying in front of the user U. The distance sensor 64 may be, for example, a light-reflective distance sensor including a light source, such as an LED or a laser diode, and a light-receiving part configured to receive reflected light emitted by the light source and reflected by the object to be measured. Further, the distance sensor 64 may be an ultrasound-type distance sensor including a sound source configured to emit an ultrasonic wave and a detection unit configured to receive the ultrasonic wave reflected by the object to be measured. The distance sensor 64 may be a laser range scanner (range-scanning sensor). In this case, a wider region including an area in front of the image display unit 20 can be scanned.

The controller 10 and the image display unit 20 are coupled via a coupling cable 40. The coupling cable 40 is detachably coupled to a connector 42 of the main body 11.

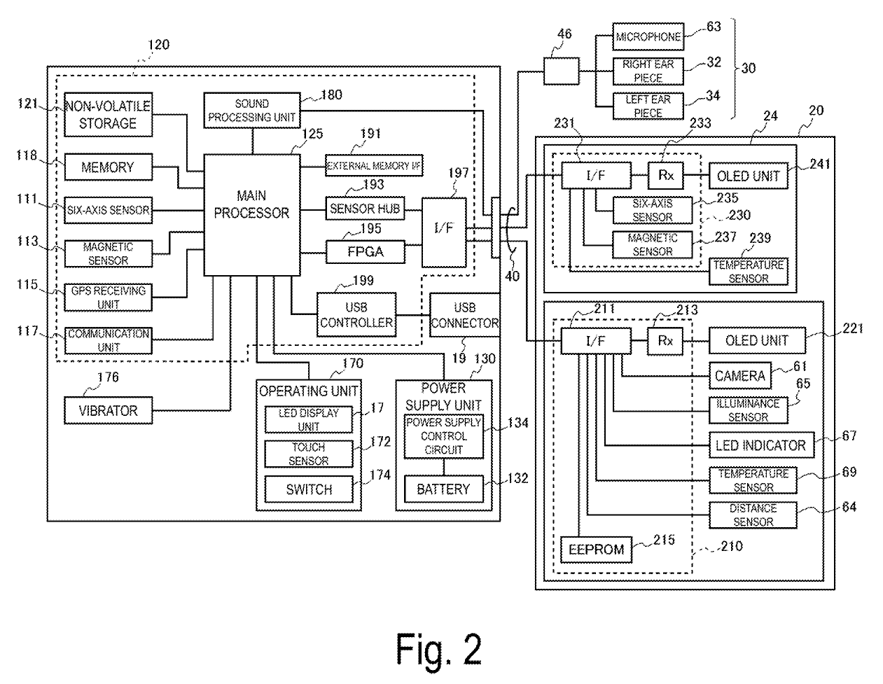

The coupling cable 40 includes an audio connector 46, and, a headset 30 including a right ear piece 32 and a left ear piece 34 included in a stereo headphone, and a microphone 63, is coupled to the audio connector 46. The right ear piece 32 is to be worn on a right ear of the user U, while the left ear piece 34 is to be worn on a left ear of the user U. The microphone 63 is configured to collect sound and output a sound signal to a sound processing unit 180 (FIG. 2). The microphone 63 may be, for example, a monaural microphone or a stereo microphone, or may be a directional microphone or a non-directional microphone.

The controller 10 includes, as parts to be operated by the user U, a wheel operating unit 12, a central key 13, the operation pad 14, an up-down key 15, an LED display unit 17, and a power switch 18. The parts to be operated are arranged on a surface of the main body 11. The parts to be operated are operated with a hand or a finger of the user U, for example.

The operation pad 14 has an operation face configured to detect a touch operation and output an operation signal in accordance with the operation performed on the operation face. A detection style for the operation face is not particularly limited, but may be an electrostatic style, a pressure detection style, or an optical style, for example. A touch (touch operation) on the operation pad 14 is detected by a touch sensor (not illustrated), for example. The operation pad 14 outputs, to the control unit 150, a signal indicative of a position on the operation face when a touch is detected.

The Light Emitting Diode (LED) display unit 17 is arranged in the main body 11. The LED display unit 17 includes a transmissive part (not illustrated) allowing light to pass through. As LEDs mounted immediately below the transmissive part come on, text, symbols, and patterns, for example, formed on the transmissive part become viewable. A touch operation performed with a hand or a finger of the user U on the LED display unit 17 is detected by a touch sensor 172 (FIG. 2). Thus, the combination of the LED display unit 17 and the touch sensor 172 serves as a software key.

The power switch 18 is used to turn on or off a power supply to the HMD 100. The main body 11 includes a universal serial bus (USB) connector 19 serving as an interface for coupling the controller 10 to an external device.

FIG. 2 is a block diagram illustrating a configuration of components configuring the HMD 100.

The controller 10 includes a main processor 125 configured to execute a program to control the HMD 100. The main processor 125 is coupled with a memory 118 and a non-volatile storage unit 121. The main processor 125 is coupled with an operating unit 170 as an input device. The main processor 125 is further coupled with sensors, such as a six-axis sensor 111, a magnetic sensor 113, and a global positioning system (GPS) 115.

The main processor 125 is coupled with a communication unit 117, the sound processing unit 180, an external memory interface 191, a USB controller 199, a sensor hub 193, and a field programmable gate array (FPGA) 195. The components function as an interface to external devices.

The main processor 125 is mounted on a controller substrate 120 built into the controller 10. In the exemplary embodiment, the controller substrate 120 is mounted with the six-axis sensor 111, the magnetic sensor 113, the GPS 115, the communication unit 117, the memory 118, the non-volatile storage 121, and the sound processing unit 180, for example. The external memory interface 191, the USB controller 199, the sensor hub 193, the FPGA 195, and an interface 197 may be mounted on the controller substrate 120. Moreover, the connector 42 and the USB controller 199 may be mounted on the controller substrate 120.

The memory 118 configures a work area used to temporarily store a program to be executed by the main processor 125 and data to be processed by the main processor 125, for example. The non-volatile storage unit 121 includes a flash memory and an embedded multi-media card (eMMC). The non-volatile storage unit 121 is configured to store programs to be executed by the main processor 125 and data to be processed by the main processor 125.

The operating unit 170 includes the LED display unit 17, the touch sensor 172, and a switch 174. The touch sensor 172 is configured to detect a touch operation performed by the user U, identify a position of the operation, and output an operation signal to the main processor 125. The switch 174 outputs an operation signal to the main processor 125, in accordance with an operation on the up-down key 15 and the power switch 18. The LED display unit 17 turns on, blinks, or turns off the LED in accordance with the control by the main processor 125. The operating unit 170 is, for example, a switch substrate on which the LED display unit 17, the touch sensor 172, the switch 174, and a circuit for controlling these are mounted, and is accommodated in the main body 11.

The six-axis sensor 111 is an example of a motion sensor (inertial sensor) configured to detect a motion of the controller 10. The six-axis sensor 111 includes a three-axis acceleration sensor and a three-axis gyro (angular velocity) sensor. The six-axis sensor 111 may include an inertial measurement unit (IMU) in which the sensors are provided as modules.

The magnetic sensor 113 is a three-axis geomagnetic sensor, for example.

The Global Positioning System (GPS) 115 includes a GPS antenna (not illustrated) and is a receiver configured to receive a radio signal transmitted from a GPS satellite. Based on a GPS signal, the GPS 115 detects or calculates coordinates of a present position of the controller 10.

The six-axis sensor 111, the magnetic sensor 113, and the GPS 115 output an output value to the main processor 125 in accordance with a predetermined sampling period. Further, the six-axis sensor 111, the magnetic sensor 113, and the GPS 115 may be configured to output, in response to a request from the main processor 125, detected values to the main processor 125 at a timing specified by the main processor 125.

The communication unit 117 is a communication device configured to execute radio communication with an external device. The communication unit 117 includes an antenna (not illustrated), a radio frequency (RF) circuit, a baseband circuit, and a communication control circuit, for example. The communication unit 117 may be a device integrated with an antenna, an RF circuit, a baseband circuit, and a communication control circuit, for example, or may be a communication module substrate mounted with various circuits.

As a communication scheme for the communication unit 117, for example, Wi-Fi (registered trademark), WiMax (Worldwide Interoperability for Microwave Access, registered trademark), Bluetooth (registered trademark), BLE (Bluetooth Low Energy), DECT (Digital Enhanced Cordless Telecommunications), ZigBee (registered trademark), UWB (Ultra Wide Band), or the like is used.

The sound processing unit 180 is coupled to the audio connector 46 (FIG. 1), and is configured to accept and output sound signals, as well as to encode or decode sound signals. The sound processing unit 180 includes an analog/digital (A/D) converter configured to convert an analog sound signal into digital sound data and a digital/analog (D/A) converter configured to convert digital sound data into an analog sound signal.

The external memory interface 191 serves as an interface configured to be coupled with a portable memory device and includes an interface circuit and a memory card slot configured to be attached with a card-type recording medium to read data, for example.

The controller 10 is mounted with a vibrator 176. The vibrator 176 includes a motor (not illustrated) and an eccentric rotor (not illustrated), for example, and is controlled by the main processor 125 to generate vibration. For example, as the operating unit 170 is operated or the power supply to the HMD 100 is turned on or off, the vibrator 176 vibrates in a predetermined vibration pattern.

The interface (I/F) 197 couples the sensor hub 193 and the field programmable gate array (FPGA) 195 to the image display unit 20.

The sensor hub 193 is configured to acquire detected values of the sensors included in the image display unit 20 and output the detected values to the main processor 125. The FPGA 195 is configured to process data to be transmitted and received between the main processor 125 and components of the image display unit 20, as well as to execute transmissions via the interface 197.

With the coupling cable 40 and wires (not illustrated) inside the image display unit 20, the controller 10 is separately coupled with the right display unit 22 and the left display unit 24.

The right display unit 22 includes an organic light emitting diode (OLED) unit 221 configured to emit imaging light. The imaging light emitted by the OLED unit 221 is guided to the right light-guiding plate 26 by an optical system including a lens group and the like. The left display unit 24 includes an OLED unit 241 configured to emit imaging light. The imaging light emitted by the OLED unit 241 is guided to the left light-guiding plate 28 by an optical system including a lens group and the like.

The OLED units 221, 241 include an OLED panel and a drive circuit configured to drive the OLED panel. The OLED panel is a light emission type display panel including light-emitting elements arranged in a matrix and each configured to emit red (R) color light, green (G) color light, or blue (B) color light, by organic electro-luminescence. The OLED panel includes a plurality of pixels, each including an R element, a G element, and a B element, arranged in a matrix to form an image. The drive circuit is controlled by the control unit 150 to select and power the light-emitting elements of the OLED panel to cause the light-emitting elements of the OLED panel to emit light. Thus, imaging light of an image formed by the OLED unit 221 and OLED unit 241 is guided to the right light-guiding plate 26 and the left light-guiding plate 28 to enter the right eye RE and the left eye LE.

The right display unit 22 includes a display unit substrate 210. The display unit substrate 210 is mounted with an interface (I/F) 211 coupled to the interface 197, a receiver (Rx) 213 configured to receive data entered from the controller 10 via the interface 211, and an electrically erasable programmable read only memory (EEPROM) 215. The interface 211 couples the receiver 213, the EEPROM 215, a temperature sensor 69, the camera 61, the illuminance sensor 65, and the LED indicator 67 to the controller 10.

The electrically erasable programmable read only memory (EEPROM) 215 is configured to store data in a manner readable by the main processor 125. The EEPROM 215 stores data about a light-emitting property and a display property of the OLED units 221 and 241 included in the image display unit 20, and data about a property of a sensor included in the right display unit 22 or the left display unit 24, for example. Specifically, the EEPROM 215 stores parameters regarding Gamma correction performed by the OLED units 221 and 241, and data used to compensate for the detected values of the temperature sensors 69 and 239 described later, for example. The data is generated when the HMD 100 is inspected before shipping from a factory, and written into the EEPROM 215. After shipment, the main processor 125 can use the data in the EEPROM 215 for performing processing.

The camera 61 captures an image in accordance with a signal entered via the interface 211 and outputs captured image data or a signal indicative of the result of imaging to the interface 211.

The illuminance sensor 65 is configured to output a detected value corresponding to the amount of received light (intensity of received light) to the interface 211. The LED indicator 67 follows a signal to be entered via the interface 211 to come on or go off.

The temperature sensor 69 is configured to detect a temperature and output, to the interface 211, a voltage value or a resistance value corresponding to the detected temperature as a detected value. The temperature sensor 69 is mounted on a rear face of the OLED panel included in the OLED unit 221, or on the same substrate as the drive circuit driving the OLED panel and detects a temperature of the OLED panel. When the OLED panel is mounted as an Si-OLED together with the drive circuit and the like to form an integrated circuit on an integrated semiconductor chip, the temperature sensor 69 may be mounted on the semiconductor chip.

The receiving unit 213 is configured to receive data transmitted by the main processor 125 via the interface 211. Upon receiving image data from the interface 211, the receiving unit 213 outputs the received image data to the OLED unit 221.

The left display unit 24 includes a display unit substrate 230. The display unit substrate 230 is mounted with an interface (I/F) 231 coupled to the interface 197 and a receiver (Rx) 233 configured to receive data entered by the controller 10 via the interface 231. Further, the display unit substrate 230 is mounted with a six-axis sensor 235 and a magnetic sensor 237. The interface 231 couples the receiver 233, the six-axis sensor 235, the magnetic sensor 237, and the temperature sensor 239 to the controller 10.

The six-axis sensor 235 is an example of a motion sensor configured to detect a motion of the image display unit 20. The six-axis sensor 235 includes a three-axis acceleration sensor and a three-axis gyro sensor. The six-axis sensor 235 may be an inertial measurement unit (IMU) including the sensors, described above, formed into a module. The magnetic sensor 237 is a three-axis geomagnetic sensor, for example.

The six-axis sensor 235 detects a rotation amount of the head of the user U. Specifically, the six-axis sensor 235 measures acceleration in an X axis direction, acceleration in a Y axis direction, and acceleration in a Z axis direction illustrated in FIG. 1. Additionally, the six-axis sensor 235 measures an angular velocity of rotation around an X axis, an angular velocity of rotation around a Y axis, and an angular velocity of rotation around a Z axis illustrated in FIG. 1, at a measurement reference point of a built-in measurement mechanism (not illustrated). The X axis, the Y axis, and the Z axis are respective three axis directions orthogonal to each other as illustrated in FIG. 1, the Z axis direction corresponds to a vertical direction, the X axis direction corresponds to a left-right direction of the head of the user U, and the Y axis direction corresponds to a front-back direction of the head of the user U. The Z axis direction corresponding to the vertical direction corresponds to a direction of a body axis of the user U. An analog voltage value outputted from the six-axis sensor 235 is converted to a digital voltage value by an A/D converter (not illustrated) and input to the control unit 150.

The temperature sensor 239 is configured to detect a temperature and output, as the detected value, a voltage value or a resistance value corresponding to the detected temperature, to the interface 231. The temperature sensor 239 is mounted on a rear face of the OLED panel included in the OLED unit 241, or on the same substrate as the drive circuit driving the OLED panel and detects the temperature of the OLED panel. Further, when the OLED panel is an Si-OLED and is implemented, together with the drive circuit and the like, as an integrated circuit on an integrated semiconductor chip, the temperature sensor 239 may be mounted on the semiconductor chip.

The camera 61, the illuminance sensor 65, the temperature sensor 69, the six-axis sensor 235, the magnetic sensor 237, and the temperature sensor 239 are coupled to the sensor hub 193 of the controller 10.

The sensor hub 193 is configured to follow a control by the main processor 125 and set and initialize sampling periods of the sensors. Based on the sampling periods of the sensors, the sensor hub 193 supplies power to the sensors, transmits control data, and acquires detected values, for example. At a timing set beforehand, the sensor hub 193 outputs detected values of the sensors to the main processor 125. The sensor hub 193 may include a function of temporarily holding detected values of the sensors in conformity to a timing of output to the main processor 125. The sensor hub 193 may include a function of responding to a difference in signal format of output values of the sensors or in data format, converting data in a format into data in a unified data format, and outputting the converted data to the main processor 125.

The sensor hub 193 follows a control by the main processor 125, turns on or off power to the LED indicator 67, and causes the LED indicator 67 to come on or blink at a timing when the camera 61 starts or ends image capturing.

The controller 10 includes a power supply unit 130 and is configured to operate with power supplied from the power supply unit 130. The power supply unit 130 includes a power supply control circuit 134 configured to detect a remaining amount of charge of a rechargeable battery 132, and control the charging of the battery 132.

The USB controller 199 is configured to function as a USB device controller, establish a communication with a USB host device coupled to a USB connector 19, and perform data communication. In addition to the function of the USB device controller, the USB controller 199 may include a function of a USB host controller.

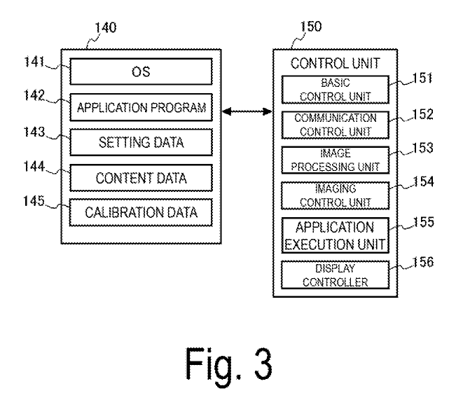

FIG. 3 is a functional block diagram of a storage 140 and a control unit 150 both configuring a control system of the controller 10 of the HMD 100. The storage 140 illustrated in

FIG. 3 is a logical storage including the non-volatile storage 121 (FIG. 2) and may include the EEPROM 215. The control unit 150 and various functional units included in the control unit 150 are formed by the main processor 125 executing a program and software and hardware working together. The control unit 150 and the functional units configuring the control unit 150 are achieved with the main processor 125, the memory 118, and the non-volatile storage 121, for example.

The storage 140 is configured to store various programs to be executed by the main processor 125 and data to be processed with the programs. The storage 140 stores an operating system (OS) 141, an application program 142, setting data 143, content data 144, and calibration data 145.

The control unit 150 executes the programs stored in the storage 140 and processes the data stored in the storage 140 to control the HMD 100.

The operating system 141 represents a basic control program for the HMD 100. The operating system 141 is executed by the main processor 125. As the power switch 18 is operated, and the power supply to the HMD 100 is turned on, the main processor 125 loads and executes the operating system 141. When the main processor 125 executes the operating system 141, various types of functions of the control unit 150 are achieved. The control unit 150 has various functions including a basic control unit 151, a communication control unit 152, an image processing unit 153, an imaging control unit 154, an application execution unit 155, and a display controller 156. The control unit 150 operates as the “display controller” and the “detection unit” according to the invention.

The application program 142 is a program to be executed by the main processor 125 while the main processor 125 executes the operating system 141. The application program 142 utilizes various types of functions of the control unit 150. The application program 142 stored in the storage 140 is not limited to one program and may be plural. For example, the application program 142 achieves functions such as image content playback, sound content playback, games, camera filming, document creating, web browsing, schedule management, telephony (including voice communication), image communication, and route navigation.

The setting data 143 includes various set values regarding operation of the HMD 100. The setting data 143 may include parameters, determinants, computing equations, look-up tables (LUTs), and the like used when the control unit 150 controls the HMD 100.

The setting data 143 includes data to be used when the application program 142 is executed. Specifically, the setting data 143 includes data such as an execution condition for executing the various types of programs included in the application program 142. For example, the setting data 143 includes data indicative of a size of an image to be displayed when the application program 142 is executed, an orientation of a screen, a functional unit of the control unit 150 to be used by the application program 142, and sensors of the HMD 100.

To introduce the application program 142, the HMD 100 uses a function of the control unit 150 to execute an installation process. The installation process is a process that includes not only storing of the application program 142 in the storage 140, but also setting of an execution condition of the application program 142 and the like. When the setting data 143 corresponding to the application program 142 is generated or stored in the storage 140 during the installation process, the application execution unit 155 can start the application program 142.

The content data 144 is data representing contents including images and videos to be displayed on the image display unit 20 through control by the control unit 150. The content data 144 includes still image data, video (moving image) data, sound data, and the like. The content data 144 may include data of a plurality of contents. The content data 144 may be data of bidirectional content.

The calibration data 145 represents data to be used to convert coordinates on captured image data of the camera 61 into coordinates on a display region VR. Within the display region VR, the image display unit 20 can display an image (virtual image). For example, when a marker or the like is captured with the camera 61, and an image is displayed on the image display unit 20 at a position overlapping the actual object being captured, the calibration data 145 representing data to be used to convert coordinates on captured image data into coordinates on the display region VR is required. For this purpose, the HMD 100 performs calibration beforehand to generate the calibration data 145 to be used to convert coordinates on captured image data into coordinates on the display region VR. The calibration data 145 being generated is stored in the storage 140 beforehand.

The basic control unit 151 executes a basic function controlling the components of the HMD 100. Upon turning on the power supply to the HMD 100, the basic control unit 151 executes a start process to initialize the components of the HMD 100 to cause the application execution unit 155 to execute the application program 142. To turn off the power supply to the controller 10, the basic control unit 151 executes a shut-down process to terminate the application execution unit 155, update various data stored in the storage 140, and stop the HMD 100. In the shut-down process, power to the image display unit 20 also stops, wholly shutting down the HMD 100.

The basic control unit 151 has a function of controlling the power supply by the power supply unit 130. With the shut-down process, the basic control unit 151 separately turns off power supplied from the power supply unit 130 to each of the components of the HMD 100.

The communication control unit 152 is configured to control the communication unit 117 to execute data communications with other devices.

For example, the communication control unit 152 receives content data supplied from an image supplying device (not illustrated) such as a personal computer by the communication unit 117, and stores the received content data in the storage 140 as the content data 144.

The image processing unit 153 is configured to generate a signal to be transmitted to the right display unit 22 and the left display unit 24 based on image data or video data to be displayed on the image display unit 20. Signals created by the image processing unit 153 may be a vertical synchronizing signal, a horizontal synchronizing signal, a clock signal, an analog image signal, or the like. The image processing unit 153 may, as necessary, perform a resolution conversion process of converting the resolution of image data into a resolution appropriate for the right display unit 22 and the left display unit 24. Further, the image processing unit 153 may also execute an image adjustment process of adjusting a brightness and chroma of the image data, a 2D/3D conversion process of creating 2D image data from 3D image data, or creating 3D image data from 2D image data, and the like. When one of the imaging processes is executed, the image processing unit 153 generates a signal for displaying an image based on the processed image data and transmits the signal to the image display unit 20.

The image processing unit 153 may be achieved when the main processor 125 executes the operating system 141 or may be a separate piece of hardware from the main processor 125. An example of the hardware includes a digital signal processor (DSP).

The imaging control unit 154 controls the camera 61 to execute capturing an image, creates captured image data, and temporarily stores the data in the storage 140. Further, when the camera 61 is configured as a camera unit including a circuit configured to create captured image data, the imaging control unit 154 acquires the captured image data from the camera 61 to temporarily store the captured image data in the storage 140.

The application execution unit 155 corresponds to a function executing the application program 142 when the main processor 125 executes the operating system 141. The application execution unit 155 executes the application program 142 to achieve various functions of the application program 142.

For example, when one of the content data 144 stored in the storage 140 is selected through an operation of the operating unit 170, the application program 142 configured to reproduce one of the content data 144 is executed. Accordingly, the control unit 150 operates as the application execution unit 155 for reproducing the content data 144.

The display controller 156 is configured to create a control signal for controlling the right display unit 22 and the left display unit 24, and control the creation and emission of the imaging light by each of the right display unit 22 and the left display unit 24. For example, the display controller 156 causes the OLED panel to execute display of an image and controls an image-drawing timing on the OLED panel, the brightness, and the like. The display controller 156 controls the image display unit 20 to display an image on the display region VR.

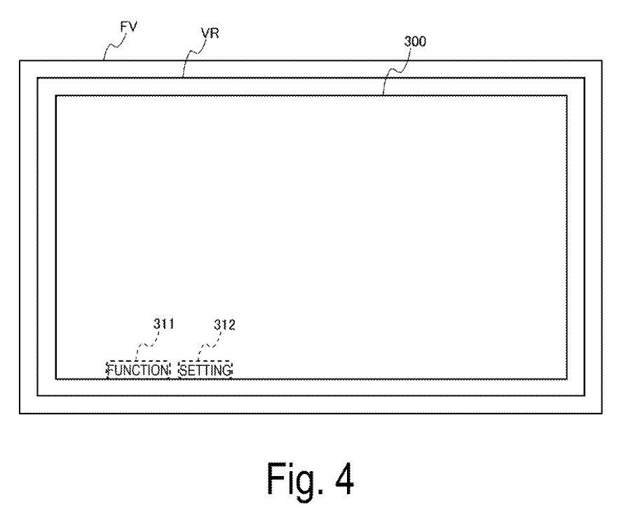

FIG. 4 is a diagram illustrating a state in which an operation screen 300 as an image is displayed on the display region VR. The operation screen 300 is a screen displayed by the main processor 125 executing the operating system 141 and the application program 142. Additionally, the operation screen 300 is a screen capable of accepting an operation performed by the user U, and is a screen for displaying functions installed on the HMD 100. The HMD 100 detects an operation performed by the user U, and performs a function selected by the detected operation. Additionally, in the exemplary embodiment, descriptions will be given using an example in which by detecting movement or a location of the indicator 5 such as a palm or a fingertip of the user U from the captured image data of the camera 61, an operation is detected, but an operation can also be performed by operating the parts to be operated such as the wheel operating unit 12, the central key 13, the operation pad 14, and the up-down key 15. Additionally, in the exemplary embodiment, descriptions will be given using an example in which the indicator 5 is a hand (including a palm, a finger, a fingertip, or the like) of the user U, but the indicator 5 is not limited to the hand, and for example, may be a pen, a pointer, or the like. When the pen, the pointer, or the like is used as the indicator 5, in order to detect an image of the pen or the pointer from captured image data, the image of the pen or the pointer needs to be stored in the storage 140 beforehand.

On the operation screen 300, a plurality of tags 311 and 312 is displayed. FIG. 4 illustrates two tags, that is, the tag 311 and the tag 312, but the number of the tags is not limited to two. The tag 311 is associated with a menu for starting functions installed on the HMD 100, such as the camera 61 and a GPS. Additionally, the tag 312 is associated with setting items for setting an operating environment of the HMD 100. Additionally, profile lines indicating regions of the tags 311 and 312 are denoted by dashed lines. The tags 311 and 312 correspond to the “object images” in the invention.

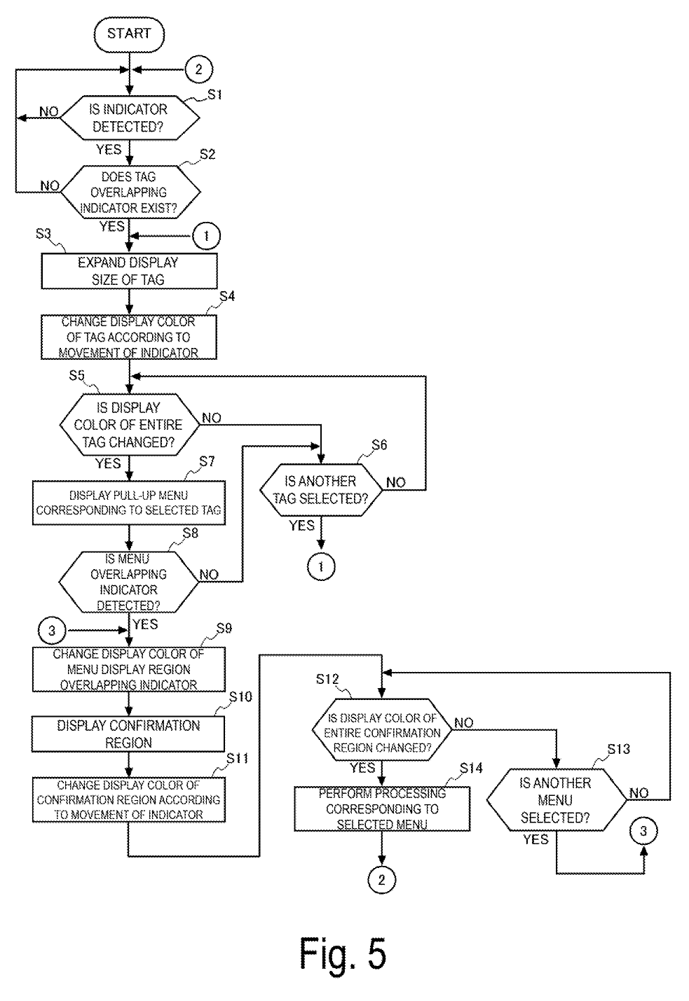

FIG. 5 is a flowchart illustrating operations of the HMD 100. The operations of the HMD 100 in the exemplary embodiment will be described with reference to the flowchart illustrated in FIG. 5.

The control unit 150 starts detecting an image of the indicator 5 from captured image data of the camera 61 (step S1). First, the control unit 150 acquires captured image data from the memory 118. The camera 61 captures an image at a preset imaging interval and generates captured image data. The captured image data of the camera 61 is temporarily stored in the memory 118. The control unit 150 acquires the captured image data from the memory 118, performs a skin extraction process, an edge detection process, or the like for the acquired captured image data, and detects an image of a finger of the user U being the indicator 5. By performing the skin extraction process for the captured image data, a region in which a skin color is captured is detected. Additionally, by performing the edge detection process, a profile or a shape of the finger of the user U captured in the captured image data is detected.

When no image of the indicator 5 can be detected from the captured image data (step S1/NO), the control unit 150 acquires next captured image data from the memory 118 and continues to detect the image of the indicator 5. Note that, the next captured image data is captured image data captured next to the targeted captured image data for detection of the image of the indicator 5. Additionally, when the imaging interval of the camera 61 is short, the control unit 150 need not target all the captured image data stored in the memory 118. For example, the control unit 150 may acquire captured image data for every preset number of sheets, from the captured image data stored in the memory 118, and detect the image of the indicator 5. In this case, the term a single sheet refers to captured image data with a preset size generated by a single capturing of the camera 61.

The control unit 150, when detecting the image of the indicator 5 from the captured image data (step S1/YES), determines whether the tag 311 or 312 overlapping the detected indicator 5 exists or not (step S2). Specifically, the control unit 150, when detecting the image of the indicator 5 from the captured image data, converts coordinate data indicating a location of the detected image of the indicator 5 in the captured image data to coordinate data indicating a location in the display region VR. The control unit 150 refers to the calibration data 145 stored in the storage 140 to convert the coordinate data indicating the location of the detected image of the indicator 5 in the captured image data to coordinate data indicating the location in the display region VR. The control unit 150, based on the converted coordinate data and respective display locations of the tags 311 and 312 in the display region VR, determines whether the tag 311 or 312 overlapping the indicator 5 exists or not.

The control unit 150, when the tag 311 or 312 overlapping the indicator 5 does not exist (step S2/NO), returns to the step S1, and acquires next captured image data from the memory 118. Additionally, the control unit 150, when the tag 311 or 312 overlapping the indicator 5 exists (step S2/YES), expands a display size of the tag 311 or 312 overlapping the indicator 5 (step S3).

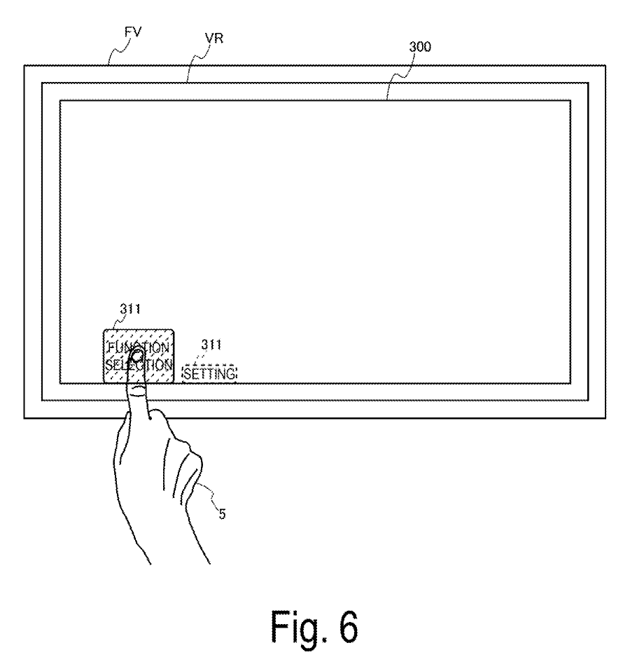

FIG. 6 is a diagram illustrating the operation screen 300 displayed in the display region VR, and especially, is a diagram illustrating a state in which the display size of the tag 311 is expanded. The control unit 150, when the tag 311 overlapping the indicator 5 is detected, changes a line type of a profile line indicating a shape or a region of the detected tag 311 from a dashed line to a solid line. Further, the control unit 150 changes a display color of the tag 311 according to movement of the indicator 5, to a color different from a display color of the unselected tag 312 (step S4). The user U moves the indicator 5 on the tag 311 to change the display color of the tag 311 to a different display color from that of the tag 312.

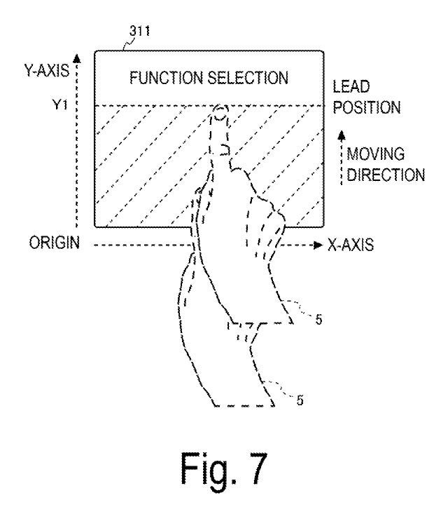

FIG. 7 is a diagram illustrating the expanded and displayed tag 311.

Here, an operation in which the display color of the tag 311 is changed according to the movement of the indicator 5 will be described with reference to FIG. 7. First, the control unit 150 identifies a direction in which the indicator 5 moves from captured image data continuously captured by the camera 61. For example, in FIG. 7, assume that an origin is set at bottom left of the tag 311, the Y axis is set along a vertical direction of the tag 311, and the X direction is set along a horizontal direction. The control unit 150 determines movement toward a positive Y axis direction is upward movement, movement toward a negative Y axis direction is downward movement, movement toward a positive X axis direction is rightward movement, and movement toward a negative X axis direction is leftward movement. In the case of the example illustrated in FIG. 7, the indicator 5 moves in the positive Y axis direction as time passes, and thus the control unit 150 determines that the movement is upward.

Next, the control unit 150 obtains a lead position of a region of the tag 311 overlapping the image of the indicator 5, in a direction in which the identified indicator 5 moves. FIG. 7 illustrates the case in which the indicator 5 moves upward, and thus the control unit 150 identifies a position with a maximum coordinate in the Y axis as the lead position. In the example illustrated in FIG. 7, the control unit 150 determines a coordinate value Yl in the Y axis as the lead position. The control unit 150 changes a display color of a region with a coordinate value of a Y coordinate equal to or less than Yl. In FIG. 7, a hatched region indicates a region of the tag 311 with the display color changed.

The control unit 150 determines whether the display color of the entire selected tag 311 is changed or not (step S5). The control unit 150, when determining that the display color of the entire tag 311 is not changed (step S5/NO), determines whether another tag is selected or not (step S6).

The control unit 150 detects the image of the indicator 5 from the captured image data, to determine whether the tag which the image of the indicator 5 overlaps is changed or not. The control unit 150, when determining that another tag is not selected (step S6/NO), returns to the determination in the step S5. Additionally, the control unit 150, when determining that another tag is selected (step S6/YES), transits to the processing in the step S3, and expands a display size of the selected other tag (step S3).

Additionally, the control unit 150, when determining that the display color of the entire tag 311 is changed (step S5/YES), determines that an operation is confirmed, and displays a pull-up menu 321 listing menus corresponding to the selected tag 311 (step S7).

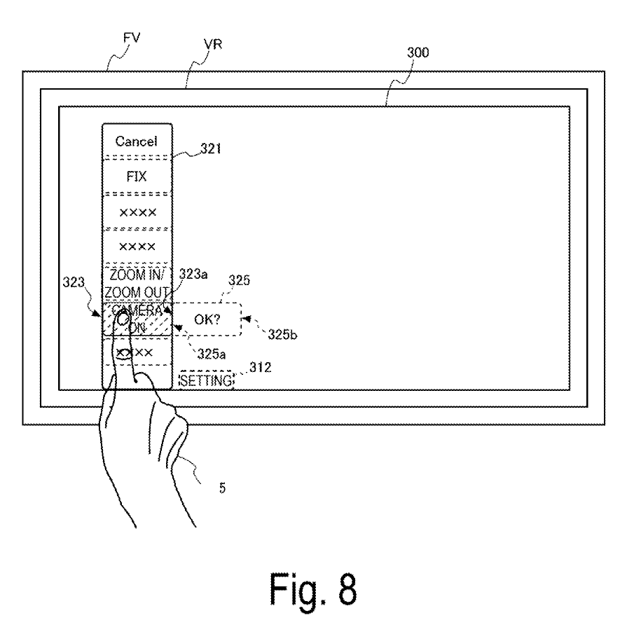

FIG. 8 is a diagram illustrating the operation screen 300 displayed in the display region VR, and especially, is a diagram illustrating a state in which the pull-up menu 321 is displayed. The pull-up menu 321 corresponds to the “object image” in the invention.

The user U, when the pull-up menu 321 is displayed on the operation screen 300, superimposes the indicator 5 on a region (hereinafter, referred to as a menu display region) 323 in which a menu to select is displayed of the displayed menus. The control unit 150 detects the image of the indicator 5 from the captured image data of the camera 61, to detect the menu display region 323 which the image of the indicator 5 overlaps (step S8). The control unit 150, when the menu display region 323 which the image of the indicator 5 overlaps cannot be detected (step S8/NO), transits to the determination in the step S6 to determine whether another tag is selected or not.

FIG. 8 illustrates a case in which the indicator 5 overlaps the menu display region 323 of “CAMERA ON” that is a menu to turn on the camera 61. The control unit 150, when detecting the menu display region 323 which the indicator 5 overlaps (step S8/YES), changes a shape of a profile line indicating a shape of the menu display region 323 from a solid line to a dashed line. Further, the control unit 150 changes a display color of the detected menu display region 323 to a color different from a display color of the rest of the menu display region 323 (step S9). In the exemplary embodiment, as an example of changing a display mode of an object image, a case of changing a display color is described, but the changing of the display color is a mere example of the changing of the display mode.

Next, the control unit 150 displays a confirmation region 325 being a display region for accepting a confirmation operation alongside the selected menu display region 323 (step S10). The control unit 150, when detecting an operation of the indicator 5 on the confirmation region 325, determines that a menu of the selected menu display region 323 is selected. The confirmation region 325 and the selected menu display region 323 are displayed alongside each other in a horizontal direction of the display region VR. Additionally, the confirmation region 325 is displayed to have contact with an end of the selected menu display region 323. In the example illustrated in FIG. 8, the confirmation region 325 is displayed along a right side of the menu display region 323, and a left end portion 325a of the confirmation region 325 contacts a right end portion 323a of the menu display region 323 of “CAMERA ON”. Additionally, a string “OK?” is displayed in the confirmation region 325. The confirmation region 325 corresponds to the “object image” in the invention.

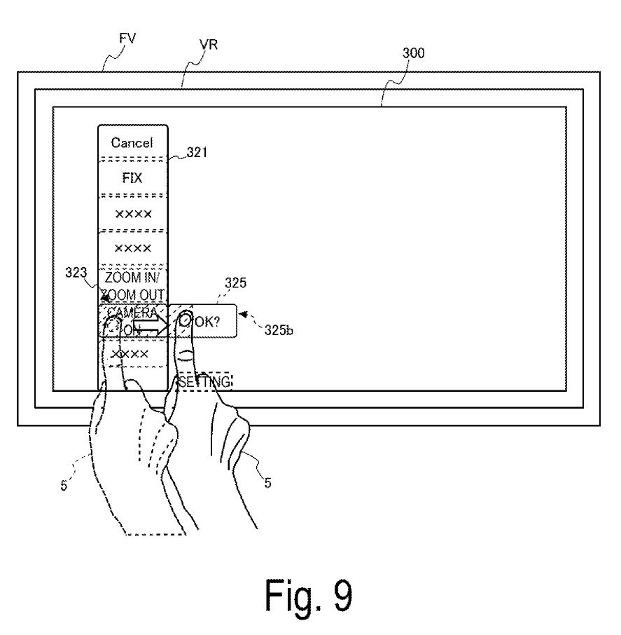

The user U, when the confirmation region 325 is displayed on the operation screen 300, and “CAMERA ON” as a menu is to be selected, slides the indicator 5 located on the menu display region 323 in a direction of the confirmation region 325, that is, from left to right as viewed by the user U. FIG. 9 is a diagram illustrating the operation screen 300 displayed in the display region VR, and especially, is a diagram illustrating a state in which the indicator 5 is slid from the selected menu display region 323 to the confirmation region 325.

The control unit 150 detects movement of the indicator 5 from the captured image data of the camera 61 being continuously captured, and changes a display color of the confirmation region 325 according to the detected movement of the indicator 5 (step S11). A method for changing the display color of the confirmation region 325 so as to correspond to the movement of the indicator 5 is similar to that in the case of the operation on the tag 311 described with reference to FIG. 7.

Additionally, when the confirmation region 325 is displayed on the operation screen 300 and the user U does not want to select “CAMERA ON” as a menu, that is, when a menu selection operation is mistakenly performed, the user U moves the indicator 5 from the menu display region 323 of “CAMERA ON” to another menu display region 323 such as “ZOOM IN/ZOOM OUT”. At this time, the displayed confirmation region 325 corresponding to the menu of “CAMERA ON” is erased and a new menu corresponding to “ZOOM IN/ZOOM OUT” is displayed.

The control unit 150 determines whether the display color of the entire confirmation region 325 is changed or not (step S12). When the display color of the entire confirmation region 325 is not changed (step S12/NO), the control unit 150 detects the image of the indicator 5 from the captured image data, and determines whether another menu displayed in the pull-up menu 321 is selected or not (step S13). The control unit 150, when another menu is not selected (step S13/NO), returns to the determination in the step S12, and determines whether the display color of the entire confirmation region 325 is changed or not. Additionally, the control unit 150, when determining that another menu is selected (step S13/YES), returns to the step S9, and changes the display color of the menu display region 323 displaying the other menu selected. Additionally, the control unit 150 displays the confirmation region 325 being a region for accepting a confirmation operation alongside the menu display region 323 with the display color changed (step S10).

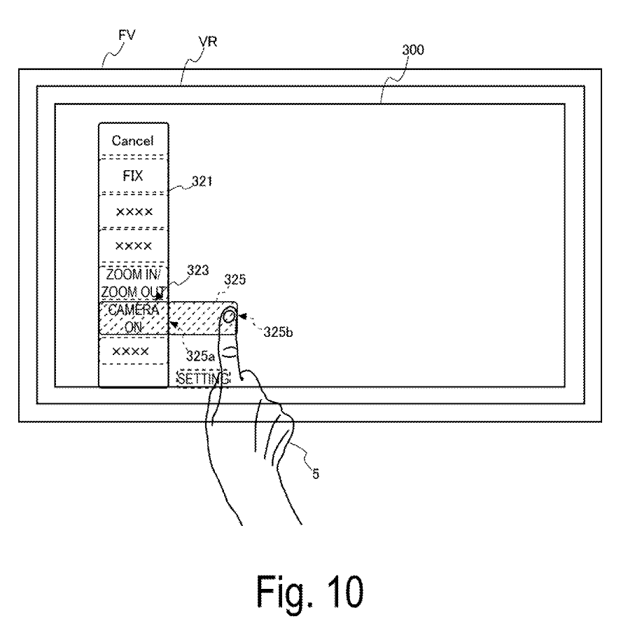

FIG. 10 is a diagram illustrating the operation screen 300 displayed on the display region VR. In particular, FIG. 10 is a diagram illustrating a state in which the display color of the entire confirmation region 325 corresponding to the selected menu display region 323 is changed. The state in which the display color of the entire confirmation region 325 is changed corresponds to a “case in which a display mode of an object image is changed corresponding to movement of an indicator on the object image” in the invention. The control unit 150, when the display color of the entire confirmation region 325 is changed (step S12/YES), determines that an operation is confirmed, and performs a process associated with the menu (a processing command) selected in the step S8 (step S14). FIG. 10 illustrates a case in which a menu for turning on the camera 61 is selected. In this case, the control unit 150 turns on the camera 61. In the exemplary embodiment, “turning on the camera 61” corresponds to, for example, causing the camera 61 to perform capturing according to an operation accepted by the operating unit 170 (shutter operation). Additionally, before the operation for turning on the camera 61 is performed, the captured image data of the camera 61 is stored in the volatile memory 118, but when the camera 61 is turned on, captured image data captured by operating the operating unit 170 is stored in the storage 140. The control unit 150, after performing a process corresponding to the selected menu, returns to the step S1, and restarts detecting the indicator 5.

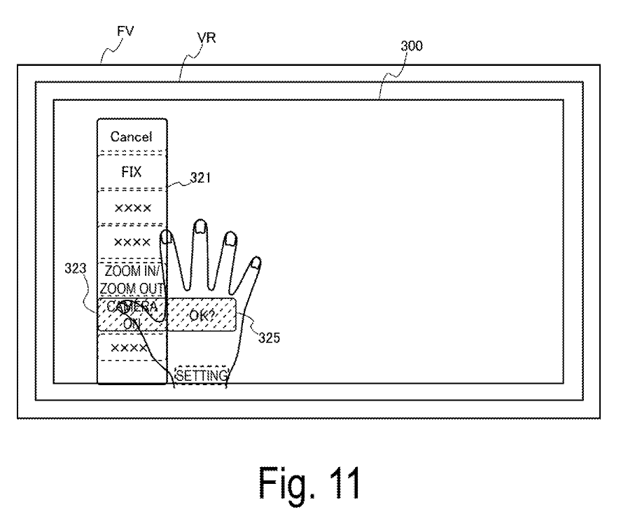

In FIG. 6 to FIG. 10, the case is described in which the movement of the indicator 5 is detected from the captured image data, and the display color of the object image is changed according to the movement of the indicator 5 on the object image such as the confirmation region 325. As another operation confirmation method, for example, as illustrated in FIG. 11, a palm as the indicator 5 may overlap the confirmation region 325, and all or nearly all of the confirmation region 325 may be hidden by the palm. The control unit 150, when determining that the indicator 5 overlaps all or nearly all of the confirmation region 325, performs the process associated with the menu (processing command) selected in the step S8.

Additionally, as another operation confirmation method, operation confirmation may be determined according to time at which the indicator 5 is detected in an object image such as the tag 311, 312, or the confirmation region 325 or in a certain range containing an object image, a traveling distance of the indicator 5 in an object image, or rest time during which the indicator 5 stands still in an object image.

Additionally, as another operation confirmation method, operation confirmation may be determined based on an area or a location of the indicator 5 overlapping an object image. For example, the control unit 150, when an area of an object image overlapping the indicator 5 is equal to or larger than a preset threshold, confirms an operation. Additionally, the control unit 150 may confirm an operation according to a location of an object image which the indicator 5 overlaps. For example, the control unit 150, when the indicator 5 is detected in a region containing a center of an object image, confirms an operation.

Additionally, the control unit 150 may determine operation confirmation by combining at least two conditions among a plurality of the above-described conditions. For example, the control unit 150 may confirm an operation according to an area of the indicator 5 overlapping an object image and rest time of the indicator 5 in the object image.

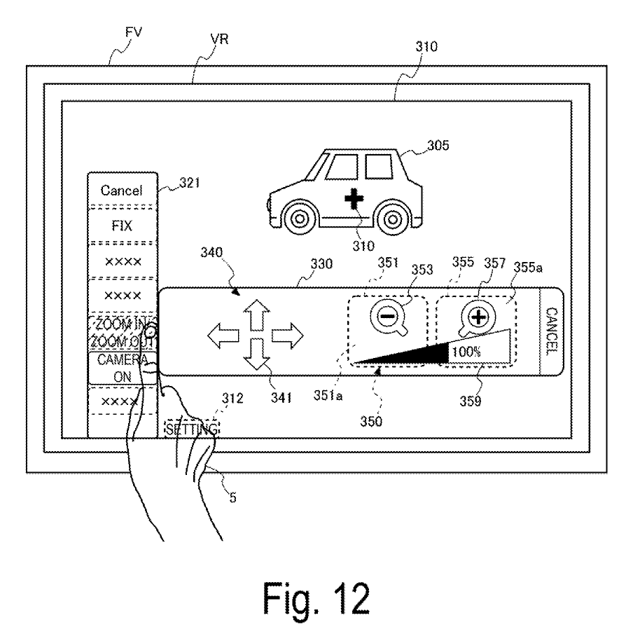

FIG. 12 to FIG. 14 are diagrams illustrating the operation screen 300 displayed on the display region VR. In particular, the respective figures are diagrams illustrating states in which an image 305 is displayed on the operation screen 300.

Next, a case will be described in which a menu is selected which expands or reduces a display size of an image. The control unit 150, when the menu display region 323 of “ZOOM IN/ZOOM OUT” is selected, displays a sub menu screen 330 corresponding to the menu of “ZOOM IN/ZOOM OUT”. In this sub menu screen 330, a movement operation region 340 for accepting an operation to move a cursor 310 displayed in the display region VR upward, downward, leftward, or rightward, and a size operation region 350 for accepting an operation to expand or reduce a display size of an image are displayed. In the movement operation region 340, a cross key 341 is displayed. Additionally, in the size operation region 350 a zoom-out button 353, a zoom-in button 357, a scaling factor display area 359, and the like are displayed. The sub menu screen 330 corresponds to the “object image” in the invention.

The cross key 341 displayed in the movement operation region 340 is a key to move a display location of the cursor 310. The zoom-out button 353 displayed in the size operation region 350 is a button to reduce a display size of the image 305 displayed on the operation screen 300, and the zoom-in button 357 is a button to expand the display size. In the scaling factor display area 359, a number or an image indicating a display scaling factor of an image is displayed.

As an operation on the sub menu screen 330, for example, the user U operates the cross key 341 to move the cursor 310 to a center of the image 305 which the user U wants to zoom in or zoom out. After the cursor 310 is moved to the center of the image 305, a reduction scaling factor or an expansion scaling factor to be specified is input by operating the zoom-out button 353 or the zoom-in button 357. The control unit 150, when the reduction scaling factor or the expansion scaling factor is input, zooms in or zooms out the image 305 with the input scaling factor. At this time, the control unit 150 reduces or expands the display size of the image 305 with a display location of the cursor 310 being a center.

FIG. 12 illustrates a case in which an operation on the size operation region 350 is available, and an operation on the movement operation region 340 is unavailable. A profile line 351 indicating an available operation range of the zoom-out button 353 is displayed as a dashed line around the zoom-out button 353 displayed in the size operation region 350. Additionally, a profile line 355 indicating an available operation range of the zoom-in button 357 is displayed as a dashed line around the zoom-in button 357. The available operation range of the zoom-out button 353 is referred to as a zoom-out operation range 351a, and the available operation range of the zoom-in button 357 is referred to as a zoom-in operation range 355a. The movement operation region 340, the cross key 341, the zoom-out operation range 351a, and the zoom-in operation range 355a correspond to the “object image” in the invention.

Displaying the respective profile lines 351 and 355 around the zoom-out button 353 and the zoom-in button 357 that are buttons capable of accepting operations, can allow the user U to recognize that the zoom-out button 353 and the zoom-in button 357 are operable and available buttons.

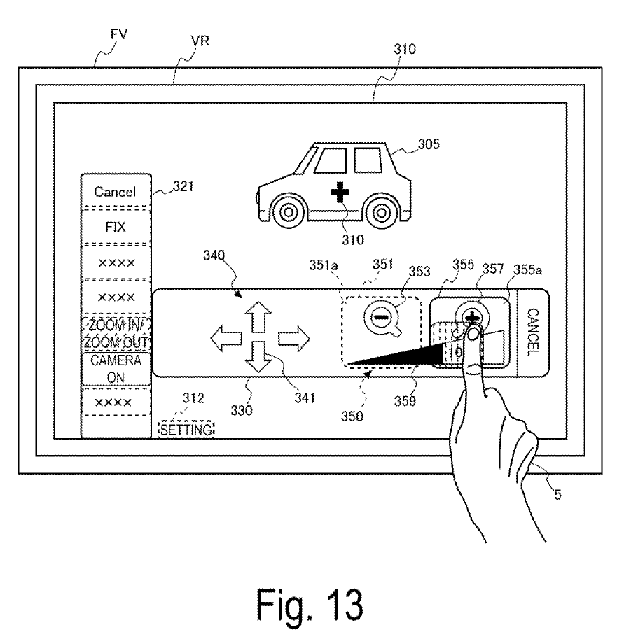

The user U, when expanding the display size of the image 305, moves the indicator 5 inward the zoom-in operation range 355a. The control unit 150 detects the image of the indicator 5 according to the captured image data of the camera 61, and when detecting the indicator 5 inside the zoom-out operation range 351a, determines that a zoom-out operation is detected, and changes a line type of the profile line 351 from a dashed line to a solid line. Similarly, the control unit 150, when detecting the indicator 5 inside the zoom-in operation range 355a, determines that a zoom-in operation is detected, and changes a line type of the profile line 355 from a dashed line to a solid line. FIG. 13 illustrates a state in which the zoom-in operation is detected, and the line type of the profile line 355 is changed from the dashed line to the solid line.

The user U, after the line type of the profile line 355 is changed from the dashed line to the solid line, moves the indicator 5 inside the zoom-in operation range 355a. For example, when the indicator 5 is moved inward the zoom-in operation range 355a from a left side of the zoom-in operation range 355a, as viewed by the user U, the indicator 5 is moved from left to right inside the zoom-in operation range 355a. Additionally, when the indicator 5 is moved inward the zoom-in operation range 355a from a lower side of the zoom-in operation range 355a, as viewed by the user U, the user U moves the indicator 5 from bottom to top inside the zoom-in operation range 355a. The control unit 150, as in the description in the step S4 in the above-described flowchart, detects the movement of the indicator 5 from the captured image data of the camera 61, and changes a display color of the zoom-in operation range 355a so as to correspond to the detected movement of the indicator 5 (see FIG. 13).

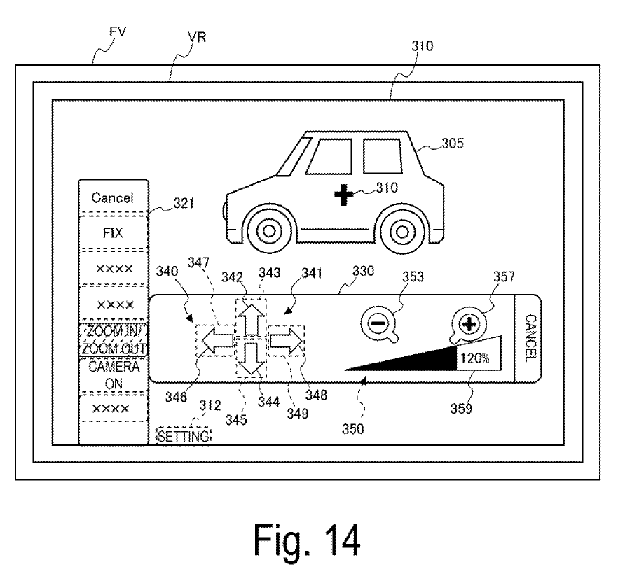

FIG. 14 is a diagram illustrating a state in which the display size of the image 305 is expanded.

The control unit 150, as described in the step S8 in the above-described flowchart, when the display color of the entire zoom-in operation range 355a is changed, expands the display size of the image displayed on the operation screen 300. Additionally, the control unit 150 displays a display scaling factor corresponding to a scaling factor after the change in the scaling factor display area 359. As for an expansion scaling factor with which a display size of an image is expanded, the operations described in FIG. 12 to FIG. 14 are assumed as a single operation, and a display scaling factor for an image may be changed by a preset scaling factor (e.g., 5%) for each single operation. Additionally, the display scaling factor displayed in the scaling factor display area 359 may be changed to a desirable display scaling factor by operating the indicator 5. For example, the user U moves the indicator 5 rightward on the scaling factor display area 359. The control unit 150 detects the rightward movement of the indicator 5 and changes the display scaling factor to a higher value. Conversely, the control unit 150, when leftward movement of the indicator 5 is detected on the scaling factor display area 359, changes the display scaling factor to a lower value. The control unit 150 expands a display size of an image with a scaling factor corresponding to the changed display scaling factor on the scaling factor display area 359. An operation in a case in which a display size of an image is reduced is similar to that in the case of expanding a display size of an image.

Additionally, after an end of an operation on the size operation region 350, an operation on the movement operation region 340 becomes available. The user U can operate the cross key 341 displayed in the movement operation region 340 to move a display location of the image 305 inside the operation screen 300. A profile line indicating an available operation range of the cross key 341 is displayed as a dashed line around the cross key 341. The cross key 341 contains an up key 342 accepting an operation for moving the display location upward, a down key 344 accepting an operation for moving the display location downward, a left key 346 accepting an operation for moving the display location leftward, and a right key 348 accepting an operation for moving the display location rightward. Additionally, a profile line 343 indicating an available operation range of the up key 342 is displayed as a dashed line around the up key 342, and a profile line 345 indicating an available operation range of the down key 344 is displayed as a dashed line around the down key 344. Additionally, a profile line 347 indicating an available operation range of the left key 346 is displayed as a dashed line around the left key 346, and a profile line 349 indicating an available operation range of the right key 348 is displayed as a dashed line around the right key 348.

The user U, as in the case of selecting the menu of “ZOOM IN/ZOOM OUT”, superimposes the indicator 5 on an operation range of a key corresponding to a direction in which the image 305 or the cursor 310 is to be moved. The control unit 150, when detecting overlap of the indicator 5 with the operation range according to captured image data, changes a display color of the operation range for which the overlap is detected so as to correspond to movement of the indicator 5. The control unit 150, when the display color of the entire operation range is changed, sets an operation of a key corresponding to the operation range for which the display color is changed as available.

Additionally, as operation modes by the cross key 341, three modes, that is, a first mode to a third mode exist. These three modes can be switched, for example, by the operating unit 170.

The first mode is a mode for moving a display location of the image 305. In this case, the cursor 310 does not move even when the cross key 341 is operated.

The second mode is a mode for moving a display location of the cursor 310. In this case, the image 305 does not move even when the cross key 341 is operated.

The third mode is a mode for moving respective display locations of both the cursor 310 and the image 305, and is a mode in which the cursor 310 and the image 305 are to be operated alternately. For example, when the cursor 310 is to be operated, the display location of the cursor 310 is moved according to the operation of the cross key 341. When the cursor 310 moves to an end (any end of up, down, left or right) of the operation screen 300, the image 305 is to be operated by the cross key 341 instead of the cursor 310. Additionally, when the image 305 moves to an end (any end of up, down, left or right) of the operation screen 300 according to the operation of the cross key 341, the cursor 310 is to be operated by the cross key 341 instead of the image 305.

Additionally, when the image 305 is moved inside the operation screen 300 by operating the cross key 341 in the third mode, for example, the cross key 341 may be operated to move the display location of the cursor 310 and superimpose the cursor 310 on the image 305. A configuration may be adopted in which the cursor 310 and the image 305 can be moved together by operating the cross key 341 when the cursor 310 overlaps the image 305.

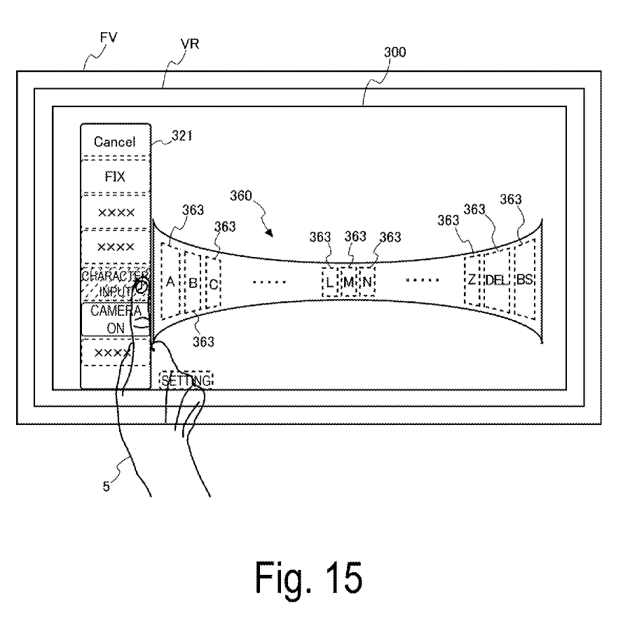

FIG. 15 is a diagram illustrating a sub menu screen 360 displayed on the operation screen 300, when a menu for inputting characters included in the pull-up menu 321 is selected.

The control unit 150, when the menu for inputting characters is selected from the pull-up menu 321, displays characters corresponding to a selected character type on the sub menu screen 360. The sub menu screen 360 corresponds to the “object image” in the invention.

FIG. 15 illustrates a case in which upper case alphabetic characters are selected as a character type, but the character type may be lower case alphabetic characters, hiragana characters or katakana characters. The sub menu screen 360 illustrated in FIG. 15 illustrates a case in which the respective alphabetic characters 363 are displayed and aligned in the alphabetic order, and additionally, a “BS” key and a “DEL” key are displayed as operation keys. Additionally, in this sub menu screen 360, characters closer to ends of the sub menu screen 360 are displayed on closer locations as viewed by the user U, and as distances to a center of the sub menu screen 360 decrease, characters are displayed on farther locations from the user U in a depth direction of the operation screen 300. For example, in the example illustrated in FIG. 15, characters such as “A”, “B”, “DEL”, and “BS” located on both the ends of the sub menu screen 360 are displayed with larger character sizes to allow the user U to visually recognize them as though the characters are displayed at closer display locations. Additionally, characters such as “M” and “N” are displayed with smaller character sizes to allow the user U to visually recognize them as though the characters are displayed at farther display locations.

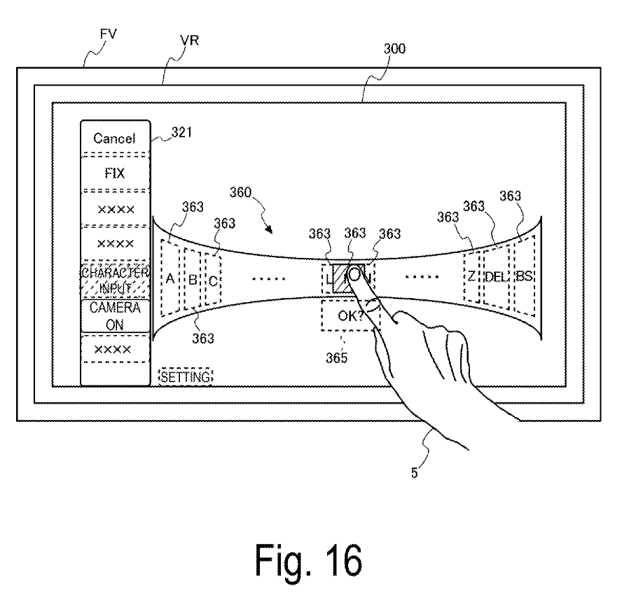

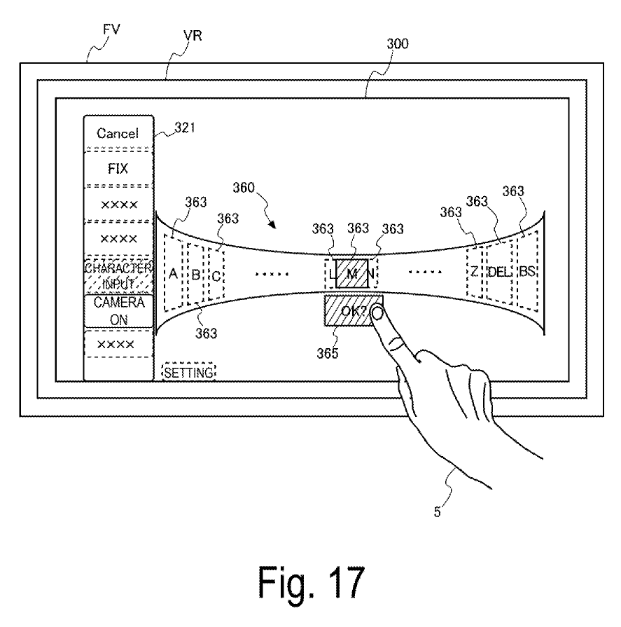

FIG. 16 and FIG. 17 are diagrams illustrating a scene in which the character 363 displayed on the sub menu screen 360 is input.

The control unit 150, when overlap of the image of the indicator 5 and a display region of the character 363 is detected, changes a profile line indicating the display region of the character 363 for which the overlap is detected from a dashed line to a solid line. The character 363 for which the overlap is detected is hereinafter referred to as the selected character 363. Additionally, the control unit 150 expands a display size of the display region of the selected character 363 so as to be larger than display sizes of display regions of other characters 363. At this time, the control unit 150, when the display region of the selected character 363 overlaps a display region of another character 363, controls display of the operation screen 300 such that the display region of the selected character 363 is displayed in front of the display region of the other character 363.

Next, the control unit 150 detects movement of the indicator 5 from the captured image data of the camera 61, and changes a display color of the display region of the selected character 363 so as to correspond to the detected movement of the indicator 5. When the display color of the entire display region of the selected character 363 is changed, the control unit 150 displays a confirmation region 365 so as to correspond to the display region of the selected character 363 (see FIG. 16). A string “OK?” is displayed in the confirmation region 365. Additionally, the control unit 150 detects the image of the indicator 5 from the captured image data, and when the image of the indicator 5 overlaps the confirmation region 365, changes a profile line indicating a region of the confirmation region 365 from a dashed line to a solid line. Further, the control unit 150 detects movement of the indicator 5 from the captured image data of the camera 61, and changes a display color of the confirmation region 365 so as to correspond to the detected movement of the indicator 5. When the display color of the entire confirmation region 365 is changed (see FIG. 17), the control unit 150 inputs the selected character 363 to a character input field (not illustrated). The confirmation region 365 corresponds to the “object image” in the invention.

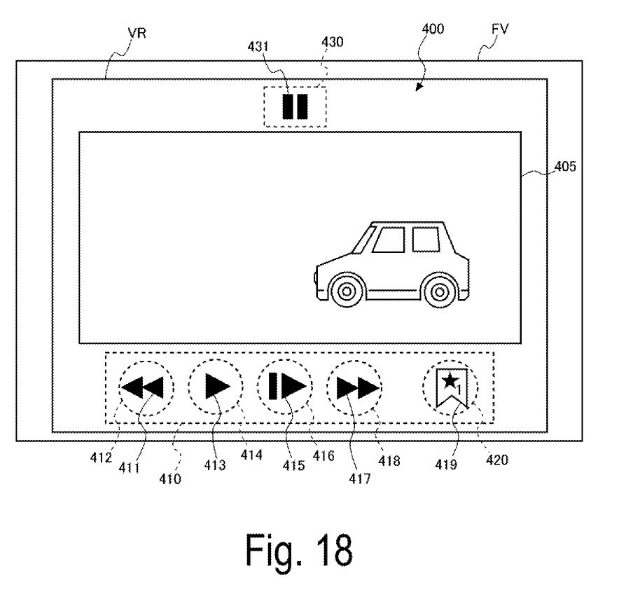

FIG. 18 is a diagram illustrating an application screen 400 displayed in the display region VR. In particular, FIG. 18 is a diagram illustrating the application screen 400 displayed when the application program 142 for playing back a moving image is selected, and the control unit 150 executes the selected application program 142.

On the application screen 400, a playback region 405 in which contents based on content data 144 are displayed, a first icon region 410, and a second icon region 430 are displayed. The first icon region 410 is a region in which operation icons to be operated by the user U are displayed. The operation icons include a rewind icon 411, a playback icon 413, a frame-by-frame playback icon 415, a fast-forward icon 417, and a bookmark icon 419. These icons correspond to the “object images” in the invention.

When the rewind icon 411 is ready to accept an operation, a profile line 412 indicating an available operation range is displayed as a dashed line.

Similarly, when the playback icon 413 is ready to accept an operation, a profile line 414 indicating an available operation range is displayed as a dashed line.

When the frame-by-frame playback icon 415 is ready to accept an operation, a profile line 416 indicating an available operation range is displayed as a dashed line. When the fast-forward icon 417 is ready to accept an operation, a profile line 418 indicating an available operation range is displayed as a dashed line.

When the bookmark icon 419 is ready to accept an operation, a profile line 420 indicating an available operation range is displayed as a dashed line.

Additionally, in the second icon region 430, an icon indicating a playback status of the content data 144 is displayed. Specifically, in a case of playing back the content data 144, an icon indicating that playback is in progress is displayed, in a case of pausing, an icon indicating the pausing is displayed, and in a case of stopping, an icon indicating a stop status is displayed. FIG. 18 illustrates a state in which the pause icon 431 indicating the pausing is displayed. The icon displayed in the second icon region 430 corresponds to the “object image” in the invention.

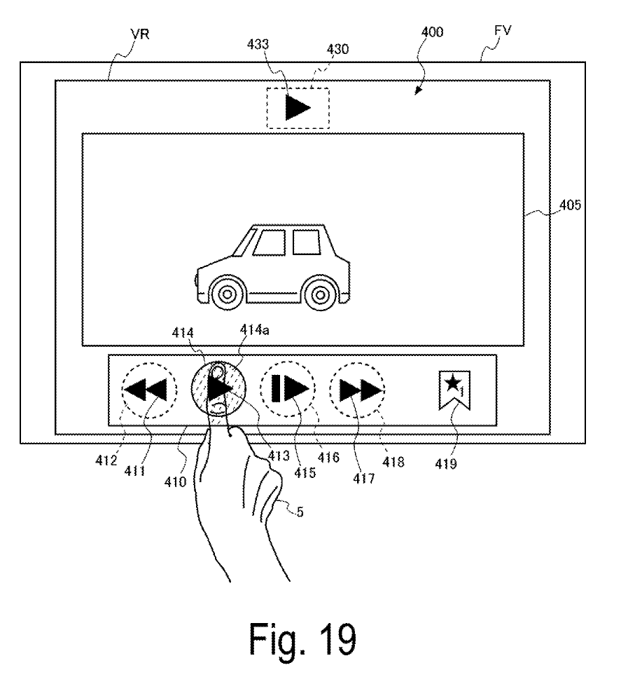

FIG. 19 is a diagram illustrating the application screen 400 displayed in the display region VR. In particular,

FIG. 19 is a diagram indicating a case in which the user U operates the playback icon 413.

The user U, when restarting the playback of the paused content data 144, moves the indicator 5 inside the profile line 414 indicating an available operation range of the playback icon 413. An inside of a range surrounded by the profile line 414 is referred to as an available operation range 414a. The control unit 150 detects the image of the indicator 5 from the captured image data of the camera 61, and when the image of the detected indicator 5 is determined to be inside the available operation range 414a, determines that a playback operation is detected, and changes a line type of the profile line 414 from a dashed line to a solid line. The playback icon 413 and the profile line 414 indicating the available operation range of the playback icon 413 correspond to the “object images” in the invention.

The user U, after the line type of the profile line 414 is changed from the dashed line to the solid line, moves the indicator 5 inside the available operation range 414a. The control unit 150 detects movement of the indicator 5 from the captured image data of the camera 61, and changes a display color of the available operation range 414a so as to correspond to the detected movement of the indicator 5. The control unit 150 determines whether the display color of the entire available operation range 414a is changed or not. The control unit 150, when detecting that the display color of the entire available operation range 414a is changed, restarts playing back the content data 144. Additionally, the control unit 150 changes the pause icon 431 displayed in the second icon region 430 to a now playing icon 433 indicating that the content data 144 is being played back.

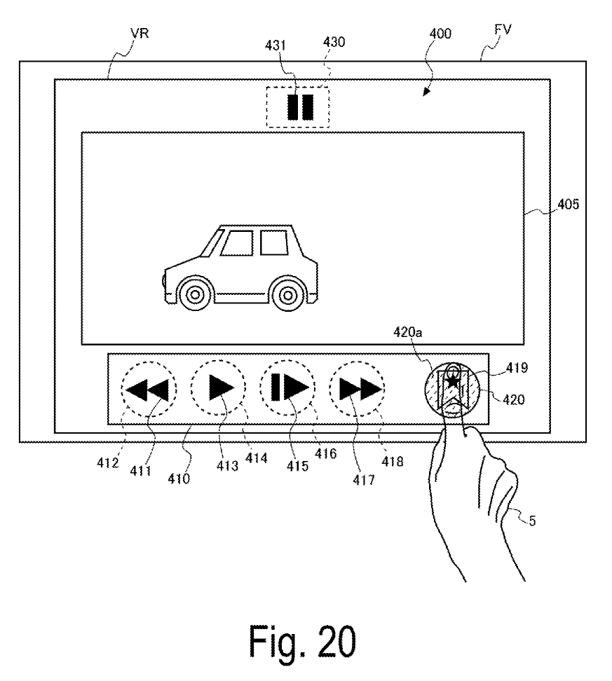

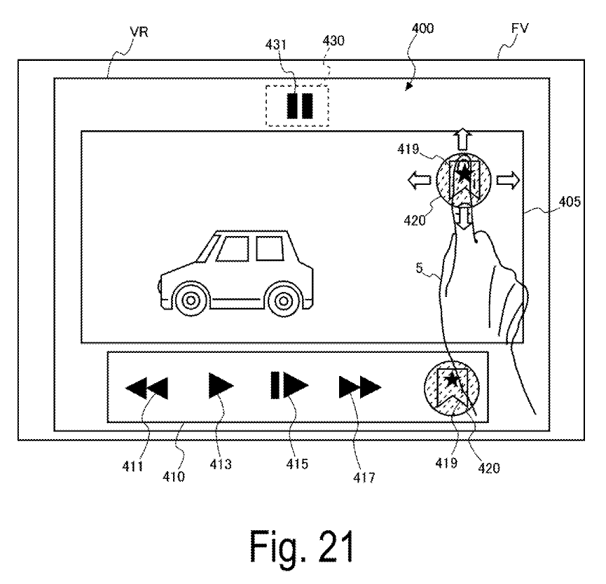

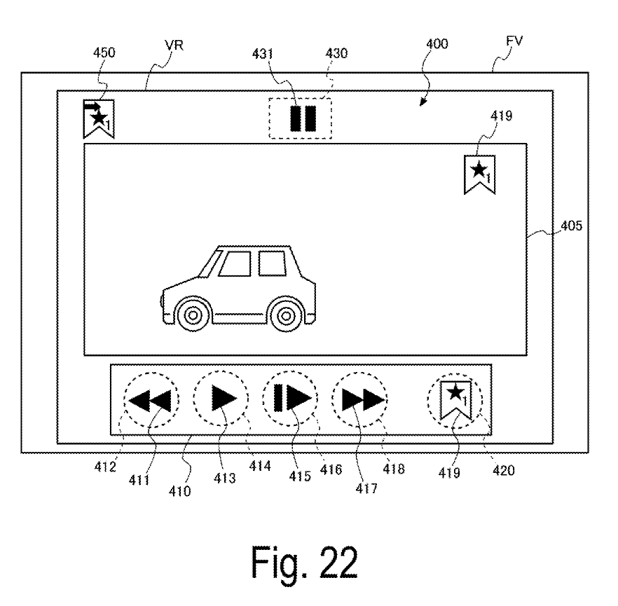

FIG. 20 to FIG. 22 are diagrams illustrating the application screen 400 displayed in the display region VR. In particular, FIG. 20 is a diagram indicating a case in which the bookmark icon 419 is operated. Additionally, FIG. 21 is a diagram illustrating a state in which a display location of the bookmark icon 419 is changed according to movement of the indicator 5. Additionally, FIG. 22 is a diagram illustrating the application screen 400 after the bookmark icon 419 is operated.

First, the user U, for example, operates the operating unit 170 to pause the playback of the content data 144. Along with the pausing, the bookmark icon is ready to accept an operation, and a profile line 420 indicating an available operation range is displayed as a dashed line. Next, the user U superimposes the indicator 5 on the bookmark icon 419. The control unit 150, when detecting that the indicator 5 overlaps an available operation range 420a of the bookmark icon 419 from the captured image data of the camera 61, changes a display color of the available operation range 420a of the bookmark icon 419. The bookmark icon 419 and the profile line 420 indicating the available operation range 420a of the bookmark icon 419 correspond to the “object images” in the invention.

Subsequently, the control unit 150 detects the image of the indicator 5 from each of the captured image data of the camera 61, which are captured continuously, and changes a display color of the available operation range 420a of the bookmark icon 419 so as to correspond to the movement of the indicator 5. The control unit 150, when the display color of the entire available operation range 420a of the bookmark icon 419 is changed, determines that an operation of the bookmark icon 419 is confirmed.

The control unit 150, when the operation of the bookmark icon 419 is confirmed, displays the bookmark icon 419 in the playback region 405 with respective arrow icons in a top, a bottom, a left, and a right directions, and the profile line 420 as a dashed line displayed (see FIG. 21). At this time, the respective displayed profile lines 412, 414, 416, and 418 of the rewind icon 411, the playback icon 413, the frame-by-frame playback icon 415, and the fast-forward icon 417, of the icons in the first icon region 410, are erased (lit out), and only the bookmark icon 419 with the arrow icons displayed is ready for input.

The control unit 150 detects the image of the indicator 5 from each of the captured image data of the camera 61, and when a location of a tip of a finger being the detected indicator 5 is determined to be inside the available operation range of the profile line 420, determines that the bookmark icon 419 with the respective arrow icons in the top, the bottom, the left, and the right directions displayed is detected. The control unit 150 changes a line type of a profile line of the bookmark icon 419 from a dashed line to a solid line, and maintains a confirmation state being a state in which a display color inside the profile line 420 is changed. Subsequently, the user U can change the display location of the bookmark icon 419 according to movement of the tip of the finger being the indicator 5. FIG. 21 illustrates a state in which the display location of the bookmark icon 419 is changed according to movement of the finger.

The user U displays the bookmark icon 419 on a desired location, and moves the indicator 5 outside the display region VR, with the movement of the indicator 5 accelerated compared to a case in which the display location of the bookmark icon 419 is changed. That is, the indicator 5 is not caused to be captured in the captured image data of the camera 61. The control unit 150, when movement speed of the indicator 5 changes rapidly and the indicator 5 is no longer detected from the captured image data, stops changing the display location of the bookmark icon 419.

Additionally, the control unit 150, when the bookmark icon 419 is displayed in the playback region 405, stores a playback time of the paused content data 144 in the storage 140. Additionally, the control unit 150 displays a jump icon 450 outside the playback region 405 (see FIG. 22). For the jump icon 450, similarly to the icons displayed in the first icon region 410, an available operation range is displayed. As for the jump icon 450, a profile line indicating that the jump icon 450 is an available icon is displayed as a dashed line around the jump icon 450, while the content data 144 is being played back. This indicates the end of the operation on the bookmark icon 419. The control unit 150, when the operation on the bookmark icon 419 ends, displays a profile line of an operable icon among the icons displayed in the first icon region 410, as a dashed line.

The control unit 150, when detecting an operation on the jump icon 450, makes the playback of the content data 144 jump. More specifically, the control unit 150, when detecting the indicator 5 overlaps the jump icon 450, makes the playback of the content data 144 jump to a playback time of the content data 144 to which the bookmark icon 419 is associated.

In the above description, the case in which the display color (hue) of the confirmation region 325 is changed so as to correspond to the operation of the indicator 5 is mentioned, but a display mode of the confirmation region 325 is preferably changed so that the user U can recognize a traveling range of the indicator 5. For example, at least one of lightness (the brightness), saturation (the chroma), and the transparency of the confirmation region 325 may be changed so as to correspond to the indicator 5.

As described above, the HMD 100 in the exemplary embodiment includes the image display unit 20 operating as the display unit, the camera 61 operating as the imaging unit, and the control unit 150 operating as the detection unit and the display controller.

The image display unit 20 is mounted on the head of the user U and is configured such that the external scene is transmissive and visually recognizable.

The camera 61 captures a range containing the external scene that passes through the image display unit 20 and is visually recognized.

The control unit 150 detects the indicator 5 from the captured image data of the camera 61.

Additionally, the control unit 150 causes the image display unit 20 to display the object image superimposed on the external scene, and changes the display mode of the object image overlapping the detected indicator 5, of the object images displayed on the image display unit 20.

Accordingly, it is possible to allow the user U to recognize the detected object image, and improve operability of the operation on the object image.

Additionally, the control unit 150, when the overlap of the indicator 5 and the object image is detected, changes the display mode of the object image.

Accordingly, it is possible to allow the user U to recognize the object image for which the overlap of the indicator 5 is detected.

Additionally, the control unit 150, between when the overlap of the indicator 5 and the object image is detected and when the movement of the indicator 5 on the object image is detected, changes the display mode of the object image.

Accordingly, it is possible to allow the user U to recognize the object image for which the overlap of the indicator 5 is detected, and allow the user U to recognize that the operation on the object image is detected.

Additionally, the control unit 150, changes the display mode of the object image corresponding to the movement of the indicator 5 on the object image.

This configuration allows the user U to recognize the operation of the indicator 5 on the object image.

Additionally, the control unit 150, when the display mode of the entire object image is changed from the display mode of the object image in the case in which the overlap of the indicator 5 and the object image is detected according to the movement of the indicator 5, performs a process associated with the object image.

Thus, by moving the indicator 5 on the object image to change the display mode of the entire object image, the process associated with the object image can be performed.

Additionally, each object image is associated with a processing command. The control unit 150 causes the image display unit 20 to display the profile line indicating the outline of the object image to which the acceptable processing command is associated, of the object images.

Accordingly, the profile line indicating the outline of the object image is displayed.

Additionally, the control unit 150, when the overlap of the indicator 5 and the object image is detected, changes the line type of the profile line of the object image for which the overlap is detected, and changes the display mode of the object image.

Accordingly, it is possible to allow the user to recognize the object image for which the overlap the indicator 5 is detected, by changing the line type of the profile line of the object image.

Additionally, the control unit 150, changes at least one of the hue, the brightness, the chroma, and the transparency of the object image corresponding to movement of the indicator 5 on the object image.

Accordingly, it is possible to allow the user U to recognize the movement of the indicator 5 in the region in which the object image is displayed.

Additionally, the control unit 150 detects the indicator 5 captured on the captured image, based on the color, the shape, or the color and shape of the indicator 5.

Accordingly, detection accuracy of the indicator 5 can be enhanced.

The invention is not limited to the configurations in the above-described exemplary embodiment, and the invention can be implemented in various aspects without departing from the gist of the invention.

For example, in the above-described exemplary embodiment, the case in which the display color of the tag 311 or the confirmation region 325 is changed according to the movement of the indicator 5 was described. As an operation other than this, the display color of the tag 311 or the confirmation region 325 may be changed according to a time during which a location of the indicator 5 overlaps the tag 311 or the confirmation region 325. The user moves the indicator 5 over the tag 311, 312, or the confirmation region 325 to select, and superimposes the indicator 5 on the selected tag 311, 312, or the confirmation region 325 for a certain time. The control unit 150 changes the display color of the tag 311, 312, or the confirmation region 325 according to the time during which the location of the indicator 5 overlaps the tag 311, 312, or the confirmation region 325.

Additionally, instead of the image display unit 20, an image display unit of another type such as an image display unit worn as a hat may be adopted, as long as the image display unit includes a display unit configured to display an image in correspondence to a left eye of the user U, and a display unit configured to display an image in correspondence to a right eye of the user U. The invention may be configured to achieve a head-mounted display to be mounted on a vehicle, such as a car and an airplane, for example. Additionally, the display apparatus in the invention may be configured, for example, as a head-mounted display built in a body protector such as a helmet. In such a case, a portion for positioning the apparatus with respect to the body of the user U, and a portion positioned with respect to the portion described earlier can be a mounting section of the head-mounted display apparatus.

Further, the controller 10 and the image display unit 20 may be configured as one part, and worn by the user U on the head. Moreover, a portable electronic apparatus including a notebook-type computer, a tablet-type computer, a game console, a portable phone device, a smart phone, and a portable media player, as well as other dedicated devices and the like may be employed as the controller 10.

Furthermore, in the exemplary embodiment, the configuration where the image display unit 20 and the controller 10 are separated and coupled via the coupling cable 40 is described; however, a configuration may be possible where the controller 10 and the image display unit 20 are coupled via a radio communication line.

As an optical system configured to guide imaging light to eyes of the user U, the right light-guiding plate 26 and the left light-guiding plate 28 may respectively use half mirrors, diffraction gratings, or prisms, for example. Furthermore, the image display unit 20 may employ a holography display unit.

Additionally, at least a portion of each function block illustrated in the block diagram may be configured to be achieved with hardware, or may be configured to be achieved t cooperation of hardware and software, and the invention is not limited to the configuration in which independent hardware resources are disposed as illustrated in the figure. Furthermore, programs to be executed by the control unit 150 may be stored in a non-volatile storage unit 121 or in another storage device (not illustrated) in the controller 10. Such a configuration may be adopted that a program to be executed is stored in an external device and acquired via the USB connector 19, the communication unit 117, and the external memory interface 191, for example. A duplicate of a configuration formed in the controller 10 may be formed in the image display unit 20. For example, a processor similar to the main processor 125 may be arranged in the image display unit 20, or the main processor 125 included in the controller 10 and the processor of the image display unit 20 may be configured to perform separate functions.

To achieve the method for controlling the head-mounted display apparatus, according to the invention, with a computer including a display apparatus, the invention may include such an aspect of a program to be executed by the computer to achieve the control method described above. Additionally, the invention may also include such an aspect of a recording medium recorded with the program being readable by the computer or a transmission medium configured to transmit the program. The recording medium described above may be a magnetic recording medium, an optical recording medium, or a semiconductor memory device. Specifically, the recording medium described above may be a portable or fixed recording medium, such as a flexible disk, a hard disk drive (HDD), a compact disk read only memory (CD-ROM), a digital versatile disk (DVD), a Blu-ray (registered trade name) disc, a magneto-optical disk, a flash memory, or a card-type recording medium. The recording medium described above may be a non-volatile storage, such as a random access memory (RAM), a read only memory (ROM), and a hard disk drive (HDD) all representing internal storages included in an image display apparatus.

The entire disclosure of Japanese Patent Application No. 2018-050713, filed Mar. 19,2018 is expressly incorporated by reference herein.

What is claimed is:

1. A head-mounted display apparatus, comprising:
a display unit to be mounted on a head of a user and configured to transmit an external scene to be visually recognizable;
an imaging unit configured to capture a range including the external scene transmitted through the display unit to be visually recognized;
a detection unit configured to detect an indicator from a captured image of the imaging unit; and
a display controller that is configured to cause the display unit to display the object image superimposed on the external scene, and that is configured to cause a display mode of the object image overlapping the indicator detected by the detection unit, of the object images displayed on the display unit, to be changed.

2. The head-mounted display apparatus according to claim 1, wherein
the display controller is configured to cause the display mode of the object image to be changed when overlap of the indicator and the object image is detected.

3. The head-mounted display apparatus according to claim 2, wherein
the display controller is configured to cause the display mode of the object image to be changed between when overlap of the indicator and the object image is detected, and when movement of the indicator on the object image is detected.

4. The head-mounted display apparatus according to claim 2, wherein
the display controller is configured to cause the display mode of the object image to be changed corresponding to movement of the indicator on the object image.

5. The head-mounted display apparatus according to claim 4, wherein
the display controller is configured to cause processing associated with the object image to be performed when the display mode of the object image is changed corresponding to movement of the indicator on the object image.

6. The head-mounted display apparatus according to claim 1, wherein
each of the object images is associated with a processing command, and
the display controller is configured to cause the display unit to display a profile line indicating an outline of the object image associated with an acceptable processing command, of the object images.

7. The head-mounted display apparatus according to claim 6, wherein
the display controller is configured to, when overlap of the indicator and the object image is detected, cause a line type of a profile line of the object image for which overlap is detected to be changed to change the display mode of the object image.

8. The head-mounted display apparatus according to claim 4, wherein
the display controller is configured to cause at least one of hue, brightness, chroma, and transparency of the object image to be changed corresponding to movement of the indicator on the object image.

9. The head-mounted display apparatus according to claim 1, wherein
the detection unit is configured to detect the indicator captured on the captured image, based on a color, a shape, or a color and shape of the indicator.

10. A method for controlling a head-mounted display apparatus to be mounted on a head of a user and configured to transmit an external scene to be visually recognizable, the method comprising:
displaying an object image superimposed on the external scene;
detecting an indicator from a captured image captured by an imaging unit; and
causing a display mode of the object image overlapping the detected indicator, of the displayed object images, to be changed.
